(19) United States
(12) Patent Application Publication
(10) Pub. No.: US 2011/0095460 A1
(43) Pub. Date: Apr. 28, 2011

(54) HYDRAULIC DECELERATIOR

(76) Inventor: Giuseppe MAFFEIS, (US)

(21) Appl. No.: 12/910,896

(22) Filed: Oct. 25, 2010

(30) Foreign Application Priority Data
Oct. 27, 2009 (IT) BS2009A000193

(51) Int. Cl. F16F 13/00

(52) U.S. Cl. 267/140.13

(57) ABSTRACT

The invention concerns a hydraulic decelerator with a fluid tank (28), in which a main piston (14) operates, and a compensation chamber (25), in which a compensation piston (15) operates. The fluid tank and the compensation chamber communicate by passing the fluid from one to the other in answer to the movements of the main piston in said tank, in a work direction under the control of a flow stop-adjustment member (12). The latter has a conical shank (22) that interacts with a cylindrical bore (31) provided in the main piston in an opposite direction through return conduits (32) also provided in the main piston associated with a one-way valve.

### FIELD OF THE INVENTION

This invention concerns a hydraulic decelerator according to the preamble of claim 1, to be used in the deceleration of devices, bodies or objects in movement such as slides, guided linear axes, rotating actuators and the like, susceptible to stopping at the end of a movement and/or to invert the direction of the movement.

### PRIOR ART

In many devices for various working processes, systems provided with alternative, repetitive movements following pre-established linear or rotary actions are used. Consequently, every stop or change of direction at the end of each stroke requires a dissipation of kinetic energy which otherwise could turn into impact forces that could be transmitted harmfully to the equipment.

A function of a hydraulic decelerator is to absorb the energy of an object in movement at the end of its controlled travel avoiding impact effects.

A hydraulic decelerator usually has a movable part compared to a fixed part and contains a hydraulic fluid, such as oil or like, between the two parts. This fluid is susceptible to passing, as a result of an axial thrust on the moving part, from a collection tank, or a high pressure chamber, to a second low pressure compensation chamber by means of one or more throttling conduits for a progressive damping action of the thrust taking place until it is nullified, and then from the compensation chamber to the collection tank for the return of the decelerator in the rest position once the thrust on the movable part has stopped.

The movable part of the hydraulic decelerator is usually designed to move into contact with the body or object to decelerate, whereas the fixed part acts as a support and guide of the movable part.

Usually, the fixed part is formed by a substantially tubular body and carries at least a regulator flow means; the movable part comprises a main piston operating in the hydraulic fluid collection tank and has a relative guide rod in the fixed part, and a compensation piston stressed by a spring and moveable in the second compensation chamber in an opposite direction to the main piston; the throttling conduits for the flow of the hydraulic fluid from the tank to the compensation chamber are provided in the main piston/or in its rod so as to interact with the flow adjuster means.

With the decelerator in an inactive position, that is resting, its fixed and moveable parts are in an extended position in which the moveable part protrudes axially from the fixed part and the hydraulic fluid is confined in the storage tank by the main piston, which is in a retracted position, and with the help of the compensation piston placed in the compensation chamber and which is in an advanced position towards the main piston.

The hydraulic decelerator activates adopting a so-called compressed position, when its moveable part is subject to an axial thrust. So, the moveable part re-enters into the fixed one, exercising a pressure on the hydraulic fluid in the tank by an advance of the main piston, causing by it, with the help of the flow adjuster, a progressive flow of the fluid towards the compensation chamber through the throttling conduits for the damping of the thrust and making the compensation piston retract.

The hydraulic decelerator disclosed in the documents U.S. Pat. No. 5,102,109, US 2009/001636, WO 2008/139780 and JP10246266 are indicative of the state of art. However these known hydraulic decelerators are not without drawbacks.

For example, the main piston has a guide rod that extends in the compensation chamber and which is guided only for a brief portion of its length in a ring at an end of the fixed body. This disposition however does not always appear to be ideal to ensure the coaxiality between the two moveable and fixed parts and to prevent flections or deviations of the rod in particular when undergoing a thrust at the time of the activation of the decelerator. Furthermore, the throttling conduits for the flow of hydraulic fluid between the collection tank and the compensation chamber have varying states, axial and radial, so much so as to complicate the realization of the piston and the relative guide rod. In addition, the adjustment of the flow of hydraulic fluid between the tank collection and the compensation chamber is carried out by difficult to produce valve means and to insert them in the decelerator. And also where, as in the document U.S. Pat. No. 5,102,109, there is a flow stop-adjustment device made up of a rod, the latter is cylindrical and designed to interact with a conical bore provided in the main piston to reach a progressive throttling effect of the flow of fluid from the tank to the compensation chamber. However, and evidently, this disposition implies the formation of a conical conduit in the main piston which has the disadvantage of compromising the possibility of being able to vary and finely adjust the degree of throttling of the conduit if not opening the device and replacing the main piston with another having a conical conduit with a different size.

### OBJECTIVE AND ADVANTAGE

The objective of this invention is to avoid the drawbacks and disadvantages of the well known technique and to correspondently propose a hydraulic decelerator simple to produce and with precise and reliable functioning.

The objective and the implicit advantages that derive from it are reached, in accordance with the invention, by a hydraulic decelerator as claimed in claim 1.

Consequently and advantageously, the flow stop-adjustment member is on board the external body and has a conical shank facing towards the main piston that is simply provided with a substantially constant axial conduit. This arrangement appears to be particularly advantageous, not only for the function of the decelerator, but also due to the fact that the flow stop-adjustment member remains accessible from the outside because of its simple removal and replacement with another different shutter-adjuster having a different conical shank depending on the required throttling progress level of the hydraulic fluid flow between the collection tank and the compensation chamber during the functioning of the decelerator. In other words, the action of the decelerator may be varied and registered without having to access its interior, but rather through an easy substitution of single component.

Furthermore, both the hydraulic fluid flow conduit from the collection tank to the compensation chamber and the return bores of the fluid from the compensation chamber to said tank are all formed in the piston, each one in parallel with the others.

According to a preferred way of realization, the axial conduit of the main piston is delimited by a sleeve, having a flexible lip acting as an opening/closing valve of the return conduits of the hydraulic fluid depending on the direction of the movement of the main piston of the system.

Also advantageously, the guide stem is centered and guided in the external body for almost all of its length, ensuring in this way that the coaxiality between said stem and the body, both in the extended rest position, and in the compressed operating position.

The collection tank of the hydraulic fluid is delimited directly by the external body, whereas the compensation chamber is in the guide stem, with the advantage that the collection tank can be compatibly ample with the dimensions of said body and that the compensation chamber, even with a reduced diameter, can develop in the direction of the length of said guide stem. This arrangement furthermore enables a continual lubrication of the coinciding surfaces, respectively internal and external, of said body and said stem from the moment that the latter during its axial movements plunges into the hydraulic fluid tank.

Also worthy of note is that when the decelerator is in the rest position, the guide stem of the main piston is stopped and held axially in the external body by means of a simple fold towards the inside of an end of said body, therefore without the need of additional components.

### BRIEF DESCRIPTION OF THE DRAWINGS

Further details of the invention will however be evident from the description that follows made in reference to the enclosed indicative and not limiting drawings, in which:

FIG. 1 is an exploded view of the components of the hydraulic decelerator according to the invention;

FIG. 2 is an external view of the assembled hydraulic decelerator;

FIGS. 3 and 4 are, magnified, a section plane and a longitudinal cross section of the assembled hydraulic decelerator, in an extended, rest position, respectively; and

FIGS. 5 and 6 show, magnified, a section plane and a longitudinal section of the assembled hydraulic decelerator, but in the compressed work condition, respectively.

### DETAILED DESCRIPTION OF THE INVENTION

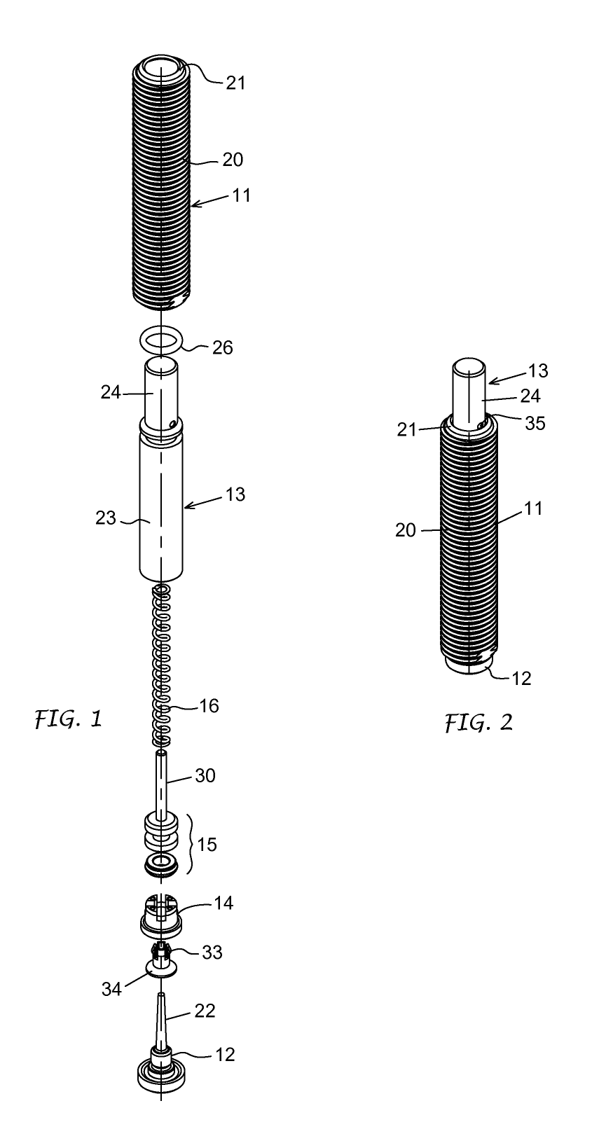

As shown, the decelerator proposed herein comprises essentially—FIG. 1—an external body 11, a flow stop-adjustment member 12, a guide stem 13, a main piston 14, a compensation piston 15 and a return spring 16.

The external body 11 can have a cylindrical shape or any other form. With its lateral wall it delimits internally a housing 17, basically cylindrical, having a proximal end 18 and a distal end 19 and designed to receive the guide stem 13. Externally, the body 11 is provided with means, such as a screw thread 20, so as to allow the fixing in use of the decelerator to a fixed support with respect to a mobile part to decelerate or on a mobile part to decelerate as it nears a fixed element. The proximal end 18 of said body has a taper, resulting from a bend towards the center and delimiting a stop shoulder 21.

The stop-adjustment member 12 has a conical shank 22. It is mounted on the distal end 19 of the external body 11 so that its conical shank 22 extends in the housing 17. Preferably, the flow stop-adjustment member 12 is fixed to the body 11 by threading and in an interchangeable form with others having from time to time a shank, always conical, but with different sizes.

The guide stem 13 includes a first portion 23, which extends axially in the housing 17 defined by the external body 11, and a second portion 24 that protrudes from the proximal end 18 of the body itself. Internally the guide stem 13 delimits a compensation chamber 25, with a variable volume, open towards the distal end of the external body and closed by the opposite part.

Altogether the guide stem 13 has a length about equal to the depth of the housing 17 in said body 11, with the length of its first portion 23 which is preferably about double the length of its second portion 24. The external surface of the first portion 23 of the guide stem 13 coincides with the internal surface of the housing 17 defined by the external body 11 and has a seal 26 which interposes between the two coinciding surfaces.

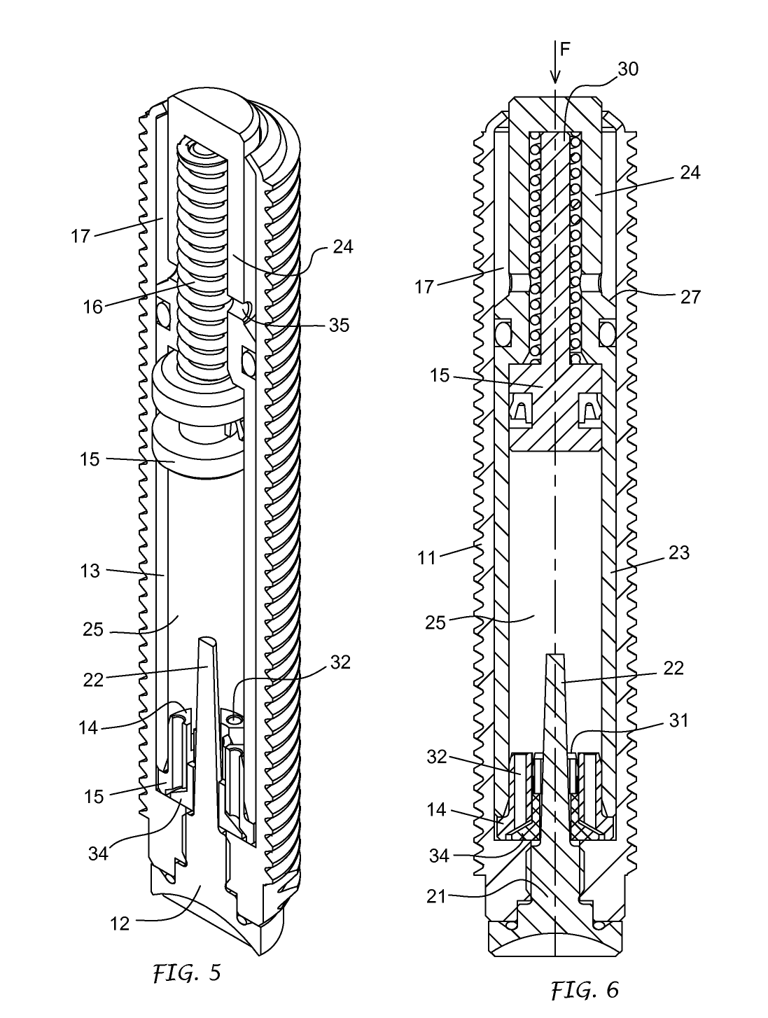

The guide stem 13 is centered and guided positively in the external body for all the length of its first portion 23 and moveable between an extended rest position—FIGS. 2-4—, in which the second portion 24 emerges axially from the proximal end 18 of the external body 11, and advanced work position—FIGS. 5, 6—, in which the stem 13 is moved towards the distal end 19 of the body 11 and correspondingly towards the stop-adjustment member 12.

Around the guide stem 13, between the first portion and the second portion 23, 24, a striking surface 27 is provided which faces towards and is designed to interact with the stop shoulder 21 at the proximal end of the external body with the dual function of preventing the extraction of the guide stem from said end of said body and to delimit the retracted rest position of the guide stem. Said guide stem will also be provided with radial bores 35 for an access and an exit of air from the guide stem, so as to allow the movements of the compensation pistons 15 without unnecessary resistances.

The main piston 14 is associated with the guide stem 13 to follow the movements thereof. It is attached to the open end of the compensation chamber 25 delimited by the guide stem, consequently, facing towards the stop-adjustment member 12. Frontally, the main piston 14 delimits a collection tank 28 with the distal end 19 and with the lateral wall of the external body 11, variable in volume and designed to contain an amortizing fluid, in particular hydraulic oil.

The compensation piston 15 on the other hand is housed in the compensation chamber 25 in the guide stem 13 with the interposition of a radial seal 29. It is moveable axially in said chamber 25 towards and away from the main piston 14 with the help of the return spring 16. This spring 16 is positioned, held and compressible between the bottom of said compensation chamber 25 and a spring guide rod 30 attached to the compensation piston 15 and acts so as to maintain the compensation piston normally moved towards the main piston.

The main piston 14 is provided with an axial conduit 31 in line with the conical shank 22 of the stop-adjustment member 12 placed at the distal end 19 of the external body 11, and two or more peripheral conduits 32 parallel to the axial conduit 31. This axial conduit is provided to place the fluid collection tank 28 in communication with the front main piston 13 together with compensation chamber 25, whereas the peripheral conduits 32 are provided for placing in communication the compensation chamber 25 with said fluid collection tank. Preferably, the axial conduit 31 is delimited by a sleeve 33 inserted in axis with the main piston 14, and this sleeve is provided with a flexible lip 34 associated at the end of the peripheral bores 32 in front of the main piston 14, that is to say facing towards the fluid collection tank 28. Said flexible lip 34 basically acts as a control valve of the opening/closing of the peripheral conduits 32 to allow a one way flow of fluid from the compensation chamber 25 to the collection tank 28 depending on the direction of the movement of the guide stem 13 together with that of the main piston 14.

In the example shown, the external body 11 forms a fixed part of the decelerator, whereas the guide stem 13 forms the moveable part, susceptible to axial movements in answer to a thrust F—FIG. 6—which is applied by any object or device in movement that needs to be decelerated at the free end of the guide stem protruding from the fixed body.

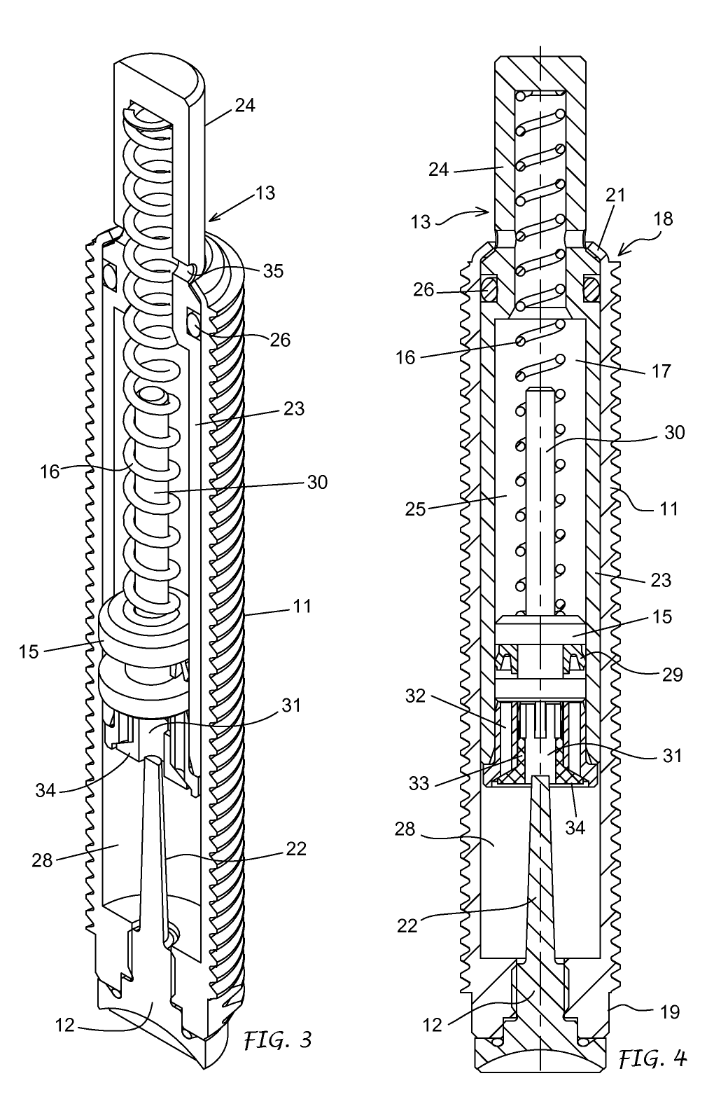

When the decelerator is in the rest position, the guide stem 13 is retracted against the stop shoulder 21 at the proximal end of the external body 11. So, on the one hand, the second portion 24 of the guide stem 13 emerges from the proximal end of the external body to meet the body or object to decelerate and, on the other hand, the main piston 14 is at a distance from the stop-adjustment member 12. Furthermore, the hydraulic fluid is contained in the collection tank; the compensation chamber 25 is basically empty; the compensation piston 15, pushed by the spring 16, is in an advanced position towards the main piston 14; the axial conduit 31 of the main piston 14 is open; the peripheral conduits 32 of the piston itself are obstructed by the flexible lip 34 acting as a valve, as shown in FIGS. 3 and 4.

When the free end of the guide stem 13 meets a body or object in movement, the axial thrust F that originates from it activates the decelerator. In fact, the guide stem 13 moves towards the distal end 19 of the external body 11, causing the main piston 14 to advance in the collection tank 28 and against the conical shank 22. So, the hydraulic fluid is compelled to pass from the collection tank 28 to the compensation chamber 25 in the guide stem 13 through the axial conduit 31 of the main piston 14, while the peripheral conduits 32 remain closed by the lip 34 of the sleeve 33 acting as a valve. So, the main piston 14 gradually advances in the collection tank 28 whereas the compensation piston 15 retracts in the compensation chamber 25 in opposition to the action of the relative spring 16. However, the hydraulic fluid flow from the collection tank to the compensation chamber becomes gradually dwindled by the consequent penetration of the conical shank 22 of the stop-adjustment member 12 in the axial conduit 31, that gradually reduces the span of the passage of the fluid—FIGS. 5, 6—resulting in the progressive reduction of the thrust F operating on the rod and consequently the deceleration of the body or object in movement until it stops.

The thrust on the guide stem ceasing, the spring 16 moves the compensation piston 15 forward causing the return of the hydraulic fluid from the compensation chamber to the collection tank 28 through the peripheral conduits 32, (where the flexible lip 34 acting as a valve opens) as well as through the axial conduit 31 of the main piston as it gradually moves away from the conical shank 22 of the stop-adjustment device 12. Therefore the main piston and the guide stem move back into the rest position, preparing the condition of the decelerator for a successive deceleration action—FIGS. 3 and 4.

1. Hydraulic decelerator for devices, bodies or objects in movement susceptible to stop at the end of a movement and/or invert the direction of the movement, comprising
an external body delimiting a housing with a proximal and a distal end and, in said housing
a main piston with a guide stem facing and protruding from the proximal end of said body,
a hydraulic fluid collection tank between said main piston and the distal end of the external body,
a flow stop-adjustment member located at the distal end of the external body and facing towards the main piston,
a compensation piston operating in a compensation chamber on the opposite part of the main piston as regards to said tank and stressed by a return spring,
and wherein
the main piston has an axial conduit for the passage of the hydraulic fluid from the collection tank to the compensation chamber and hydraulic fluid return conduits from said compensation chamber to said collection tank, and
the main piston is movable between a back rest position away from the flow stop-adjustment member, where the guide stem protrudes from the proximal end of the external body, the compensation piston is contiguous to the main piston and the hydraulic fluid is confined in the collection tank, and a forward compression position towards the distal end of the external body, in which the flow stop-adjustment member interacts with the axial bore of the main piston for a progressively narrowed passage of the hydraulic fluid from the collection tank to the compensation chamber while the return conduits are kept closed, so as to cause a movement of the compensation piston in an opposite direction to that of the main piston and a deceleration action of a body or object in movement which the decelerator is associated with, wherein said flow stop-adjustment member is fixed to the distal end of the external body and has a conically tapered shank that extends in said hydraulic fluid collection tank, wherein said axial conduit of the main piston cooperating with said flow stop-adjustment member for the passage of the hydraulic fluid from the collection tank to the compensation chamber is cylindrical and the return conduits of the hydraulic fluid from said compensation chamber to said collection tank are round and parallel to the axial bore.

2. Hydraulic decelerator according to claim 1, wherein said flow stop-adjustment device is screwed to the external body and is removable for the replacement with others with a different taper.

3. Hydraulic decelerator according to claim 1, wherein said axial conduit is delimited by a sleeve inserted and restrained in the main piston and having a flexible lip associated with said return conduits acting as valves to close said return conduits when the main piston moves towards the forward compression position and to open said return conduits when the decelerator takes on the extended rest position.

4. Hydraulic decelerator according to claim 1, wherein the guide stem of the main piston has a first portion that extends and is axially guided in the housing defined by the external body, and a second portion that protrudes from the proximal end of said body, said first portion being about double the length of said second portion.

5. Hydraulic decelerator according to claim 1, wherein the hydraulic fluid collection tank is delimited by an external body of the main piston and distal end of said main piston and the compensation chamber is delimited by said guide stem.

6. Hydraulic decelerator according to claim 4, wherein the guide stem has a cavity that defines the compensation chamber communicating with the hydraulic fluid collection tank, and wherein the compensation piston is housed with the relative return spring in said stem.

7. Hydraulic decelerator according to claim 6, wherein the return spring is positioned, retained and compressible between a bottom of said compensation chamber and a spring guide rod attached to the compensation piston.

8. Hydraulic decelerator according to claim 1, wherein at least one hydraulic seal is arranged between the guide stem and the external body.

9. Hydraulic decelerator according to claim 4, wherein a striking surface is provided between the first and second portions of the guide stem, and wherein a stop shoulder is provided at the proximal end of the external body for interacting with said striking surface to prevent the extraction of the guide stem from said extremity of the external body and to delimit the retracted rest position.

10. Hydraulic decelerator according to claim 9, wherein said shoulder is defined by a bend of the proximal end of the external body towards the guide stem.

11. Hydraulic decelerator according to claim 9, wherein the guide stem has a vent on a level with said striking surface.

12. Hydraulic decelerator according to claim 2, wherein said axial conduit is delimited by a sleeve inserted and restrained in the main piston and having a flexible lip associated with said return conduits acting as valves to close said return conduits when the main piston moves towards the forward compression position and to open said return conduits when the decelerator takes on the extended rest position.

13. Hydraulic decelerator according to claim 5, wherein the guide stem has a cavity that defines the compensation chamber communicating with the hydraulic fluid collection tank, and wherein the compensation piston is housed with the relative return spring in said stem.
